(19) United States
(12) Patent Application Publication
(10) Pub. No.: US 2002/0077877 A1
(43) Pub. Date: Jun. 20, 2002

(54) System and method for project management and assessment

(75) Inventor: Michael E. Oliver, Etters, PA (US)

Correspondence Address: David G. Wille, Baker Botts, L.L.P., 2001 Ross Avenue, Dallas, TX, 75201-2980, US

(73) Assignee: ELECTRONIC DATA SYSTEMS CORPORATION

(21) Appl. No.: 09/742,793

(22) Filed: Dec. 20, 2000

(51) Int. Cl. G06F 17/60

(52) U.S. Cl. 705/8

(57) ABSTRACT

The present invention provides a system (100) for monitoring and assessing the performance of a project, which system includes a computer (120) and a software program associated with the computer (120), with the software program and computer (120) operable in combination to receive project task data and earned value information from a project management software file, determine cost depletion date information, and graphically displaying the cost depletion date information. The present invention also provides a method for monitoring and assessing the performance of a project, which method includes obtaining the task data and earned value information from a project management software file; determining cost depletion date information; and displaying cost depletion date information.

### TECHNICAL FIELD OF THE INVENTION

The invention relates to project management systems and methods, and more particularly to a software-based system and method for project management and assessment.

### BACKGROUND OF THE INVENTION

Good project management is an important factor to the success of a project. A project may be thought of as a collection of activities and tasks designed to achieve a specific goal of the organization, with specific performance or quality requirements while meeting any applicable time and cost constraints. Project management refers to managing the activities that lead to the successful completion of a project. Project management focuses on finite deadlines and objectives. A number of tools may be used to assist with project management and assessment.

A fundamental scheduling technique used in project management is the Critical Path Method (CPM). With this model, the tasks that must be completed are determined and task data developed for each. The task data may include the start date, time required, sequencing requirements, finish date, cost effort, and resources. When all the tasks are determined, the path of tasks on the longest sequence for completion of the project becomes what is known as the “critical path” and the tasks on it “critical tasks.” The sequencing of tasks in the project may be graphically presented in what is known as a PERT chart. The tasks and their duration may also be presented with a bar chart known as a Gantt chart.

A typical large project may be thought of as having four phases: (a) start up, (b) planning, (c) execution, and (d) close-down. During the planning phase, the numerous tasks that make up the project are determined and task data for each are determined. A baseline may be established when all of the project stakeholders concur on the appropriate plan. The baseline is the approved project plan (amount and timing) for a work assignment, output, set of outputs, or overall project. As used here, cost is an all-inclusive term that includes either dollars or effort hours. The baseline represents cost and effort expenditures with respect to time and activities. The resources necessary to complete project activities provide the basis for determining the cost and effort requirements. This determination is initially performed in the project planning stage and revisited whenever baseline revisions are deemed necessary.

The baseline is referenced throughout the project with the actual data. The actual data refers to the start and finish dates for tasks and actual costs, e.g., actual effort hours, applied or spent on a work assignment, output, set of outputs, or the overall project. At periodic time intervals during the project, the actuals and baseline are compared to determine a variance from the plan and also to forecast anticipated completion dates and costs for all remaining work. The forecast is the predicted cost, e.g., effort hours, to be spent to complete the remainder of a work assignment, output, set of outputs, or the overall project.

Many project schedule management software (collectively “project management software”) are commercially available, such as Microsoft® Project, which comes in numerous versions such as Microsoft® Project for Windows® 95. Such software allows for task data such as duration, start date, finish date, and resources to be entered. As the project advances, information on actual performance may be entered and information developed and presented concerning the performance of the project to date. See generally, Tim Pyron and Kathryne Valentine, Using Microsoft® Project for Windows® 95 (special ed. 1996).

Certain project management software can also provide earned value (EV) analysis information. In managing a project, earned value (EV) analysis is applied to provide an objective measurement of a project's cost and schedule performance, thereby facilitating objective analysis of the project's cost and schedule. For example, by comparing earned value with a baseline, the value of the work accomplished is compared to the value of the work planned. By comparing earned value and actuals, the value of work accomplished is compared to the value of the costs actually spent.

However, these project management software do not provide sufficient or readily accessible cost depletion date (CDD) information, i.e., the anticipated date at which the project's actual costs may exceed the authorized or planned budget at completion (BAC). During the execution period of a typical large project, as discussed above, certain cost concerns may arise. For example, what is the project's current cost performance, and if the current cost performance trend continues, by what date will the projects actual costs exceed the authorized or planned budget at completion?

### SUMMARY OF THE INVENTION

Therefore, a need exists for a software-based system and method for project management and assessment that provides detailed cost depletion date (CDD) information and related analysis information.

In one aspect of the present invention, a system is provided for monitoring and assessing the performance of a project. The system includes a computer and a software program associated with the computer. The software program and computer are operable in combination to: (1) receive project task data and earned value information from a project management software file or a historical data file; (2) determine cost depletion date (CDD) information from the project task data and earned value information; and (3) display the cost depletion date information. The cost depletion date information can include cost depletion date related information.

In another aspect of the present invention the software program and computer are operable to obtain the CDD information by: (1) calculating a cumulative cost performance index (CPI) and a cumulative schedule performance index (SPI) at a current reporting date (CRD) from the project task data, or the earned value information, or both; (2) utilizing the cumulative CPI and SPI to calculate a cumulative actual cost of work performed (ACWP) and a cumulative budgeted cost of work performed (BCWP)for each reporting period from the CRD to a project baseline finish date; and (3) determining a cost depletion date at which the cumulative actual cost of work performed (ACWP) is equal to or greater than the budget at completion (BAC).

In still another aspect of the present invention, the software program and computer are operable to determine the CDD information by: (1) calculating a cumulative cost performance index (CPI) and a cumulative schedule performance index (SPI) at a current reporting date (CRD) from the project task data, or the earned value information, or both; (2) utilizing the cumulative CPI and SPI to calculate a cumulative actual cost of work performed (ACWP) and a cumulative budgeted cost of work performed (BCWP) for a successive reporting period following the CRD; and (3) setting a cost depletion date equal to the reporting period being analyzed if the cumulative actual cost of work performed (ACWP) is equal to or greater than the budget at completion (BAC). The last two steps are repeated for each successive reporting period until a project baseline finish date is reached.

In still another aspect of the present invention, a method is provided for monitoring and assessing the performance of a project. The method includes (1) receiving project task data and earned value information from a project management software file or a historical data file, (2) determining cost depletion date (CDD) information from the project task data and earned value information, and (3) displaying the cost depletion date information. The cost depletion date information includes cost depletion date related information.

In still another aspect of the present invention, a method is provided, which method obtains CDD information by: (1) calculating a cumulative cost performance index (CPI) and a cumulative schedule performance index (SPI) at a current reporting date (CRD) from the project task data, or the earned value information, or both; (2) utilizing the cumulative CPI and SPI to calculate the cumulative actual cost of work performed (ACWP) and the cumulative budgeted cost of work performed (BCWP) for each reporting period from the CRD to a project baseline finish date; and (3) determining a cost depletion date at which the cumulative actual cost of work performed (ACWP) is equal to or greater than the budget at completion (BAC).

In still another aspect of the present invention, a method is provided, which method obtains the CDD information by: (1) calculating a cumulative cost performance index (CPI) and a cumulative schedule performance index (SPI) at a current reporting date (CRD) from the project task data, or the earned value information, or both; (2) utilizing the cumulative CPI and SPI to calculate a cumulative actual cost of work performed (ACWP) and a cumulative budgeted cost of work performed (BCWP) for a successive reporting period following the CRD; and (3) setting a cost depletion date equal to the reporting period being analyzed if the cumulative actual cost of work performed (ACWP) is equal to or greater than the budget at completion (BAC) The last two steps are repeated for each successive reporting period until a project baseline finish date is reached.

### BRIEF DESCRIPTION OF THE DRAWINGS

For a more complete understanding of the present invention and advantages thereof, reference is now made to the following description taken in conjunction with the accompanying drawings in which like reference numerals indicate like features and wherein:

FIG. 1 is a Gantt chart for an exemplary project with which the present invention may be utilized;

FIG. 2 is an exemplary graphical display of project data and cost depletion date information for a project according to the present invention;

FIG. 3 is a perspective view of an exemplary system in accordance with the present invention;

FIG. 4 is a block diagram of an exemplary architecture of the system of FIG. 3;

FIGS. 5a and 5b are flowcharts illustrating one exemplary process flow for a method according to the present invention; and

FIG. 6 is an exemplary graphical display of statistical cost depletion date information for a project according to the present invention.

### DETAILED DESCRIPTION OF THE INVENTION

Preferred embodiments of the present invention are illustrated in FIGS. 1-6 of the drawings, like numerals being used for like and corresponding parts of the various drawings.

Cost depletion date (CDD) information and related analysis information provides an objective forecast of when a project's actual costs may exceed the authorized or planned budget at completion (BAC). Accordingly, CDD information and related analysis provides an advantage when there is a cost variance, i.e., when actual costs exceed budgeted costs at a reporting date being analyzed. A project manager having this information can then have sufficient lead time to plan ahead and secure additional funding for the project or pursue other appropriate responses.

CDD information and related analysis information can be obtained from task data (e.g., such as, duration, start date, finish date, and allocated resources) and earned value (EV) information and EV-related information. EV information and EV-related information are well known to the skilled artisan, as described in U.S. Pat. No. 5,907,490 issued May 25, 1999 to Oliver, which is incorporated herein by reference in its entirety.

A simple example will illustrate the need for CDD information and related analysis information. Referring to FIG. 1, a Gantt chart for an exemplary project with which the present invention may be utilized is shown. The project includes the following seven tasks, which are listed on the ordinate axis 12: Task A 14, Task B 16, Task C 18, Task D 20, Task E 22, Task F 24, and Task G 26. The abscissa axis 10 reflects reporting time increments in weeks. For simplicity, the chart has been prepared with the understanding that each task will be completed by a single worker and that the worker will devote forty effort hours per week to the task. Accordingly, Task A 14 is scheduled to be completed by one worker during week 1; Task B 16 and Task D 20 are scheduled to be completed by two workers during week 2; Task C 18 and Task E 22 are scheduled to be completed by two workers during week 3; Task F 24 is scheduled to be completed by one worker during week 4; and Task G 26 is scheduled to be completed by one worker during week 5. Accordingly, the Budget at Completion (BAC) for Tasks A-G is scheduled to be 280 effort hours. The scheduling shown in the Gantt chart of FIG. 1 is done in the planning process, and as scheduled, constitutes the baseline for the project.

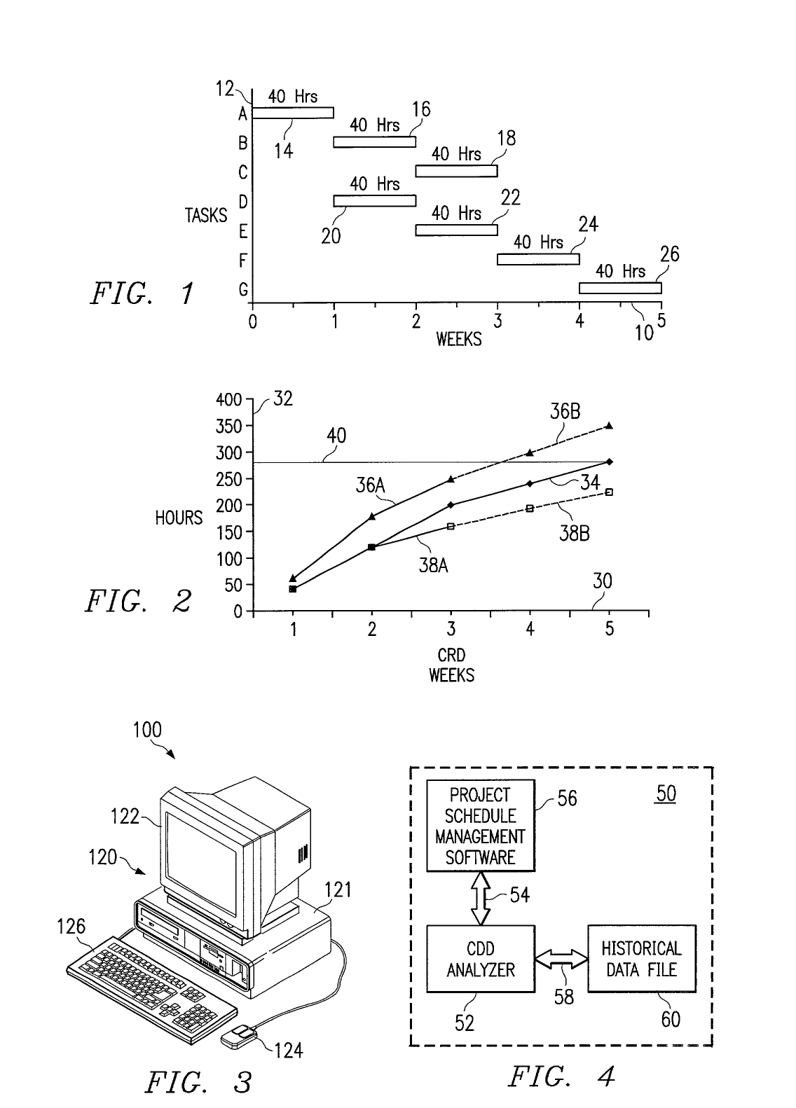

Referring now to FIG. 2, an exemplary graphical display is provided to illustrate project data, EV information, and CDD information for a project according to the present invention. The baseline pattern for the delivery of effort hours is shown in the graph based on exemplary information from FIG. 1. The earned value data and actuals are also shown. The graph has on its abscissa axis 30 the reporting time increments in weeks. Note that the reporting time increments can be changed to any appropriate time period, e.g., each day or each month.

The ordinate axis 32 shows the cumulative effort hours for the project. The baseline is graphically illustrated by line 34. This baseline is called the cumulative budgeted cost of work scheduled curve (cumulative BCWS), which is derived from the work scheduled from the Gantt chart of FIG. 1. The budget at completion (BAC) is illustrated by line 40, which is the total effort hours, e.g., 280 effort hours, at the end of the BCWS curve. The actual effort hours expended is represented by the cumulative cost of work performed curve (cumulative ACWP), which is illustrated by line 36A. The earned value information is represented by the cumulative budgeted cost of work performed curve (cumulative BCWP), which is illustrated by line 38B.

For example, at the current reporting date (CRD) e.g., at the end of week 3, tasks A-F had been scheduled to be completed at 200 effort hours, as illustrated by line 34. Of these tasks, all are complete except Task E, rendering a BCWP of 160 hours. According to FIG. 2, however, about 250 actual effort hours were expended on tasks A-F. Based on the performance at the current reporting date (CRD), e.g., at the end of week 3, the projected cumulative ACWP curve, illustrated by line 36B, and the projected cumulative BCWP curve, illustrated by line 38B, can be determined, as will be described in detail below. The intersection of the projected cumulative ACWP curve 36B with the budgeted cost at completion line 40 illustrates the estimated cost depletion date, i.e., at about the middle of the third week.

This simple example shows the importance of objectively tracking the actual cost of completed tasks during project management by utilizing scheduled, actual, and EV information. While not always needed, a CDD analysis can prove to be very important, because cost trends that develop during the completion of a project can be used to identify potential long-term problems related to performance factors or areas of concern for an overall project. CDD analysis can, therefore, be used to develop a plan to provide early resolution of such problems. Typically, CDD analysis is most helpful when there is a cost variance at any current reporting date (CRD), i.e., when cumulative ACWP is greater than cumulative BCWP at a reporting date being analyzed.

Referring to FIG. 3, a perspective view of an exemplary system in accordance with the present invention is shown. Exemplary system 100 for project management and assessment includes a microprocessor-based computer 120. Computer 120 preferably has an Intel 80x86 microprocessor, such as an 80486 or Pentium that may be housed in a main computer portion 121. Computer 120 is preferably capable of running Microsoft Windows® Version 3.1 or higher and Microsoft® Project (MP) or other project management software. Computer 120 will typically include components, such as an internal hard drive or other suitable program memory, and/or one or more disc drives for uploading programs and data. Computer 120 may also include other devices, such as a CD ROM drives, optical drives and/or other devices. Computer 120 includes a sufficient amount of memory to support its operating system as well as all applications and utility software desired to run on computer 120.

Computer 120 further includes a display screen 122, which may have a graphical user interface (GUI). Computer 120 may receive input from a touch screen; a pointing device 124, which may be any of a number of devices, such as a mouse, a touch pad, a roller ball, or other devices; and may also receive input through keyboard 126. Computer 120 is further programmable and operable to perform CDD analysis according to the system and methods of the present invention. The programming of computer 120 to carry out the steps discussed herein, may be accomplished with any number of computers and any number of programming languages or applications (e.g., BASIC, VISUAL BASIC, FORTRAN, PASCAL, AND COBAL), but in a preferred embodiment, is programmed using Microsoft®'s VISUAL BASIC.

Referring now to FIG. 4, a block diagram of an exemplary architecture 50 within the system of FIG. 3 is shown. As an important aspect of the present invention, a software module or programming segment 52 is used to calculate and display CDD information and CDD-related information. As used herein, CDD information means the cost depletion date, and CDD-related information means any information relating to the cost depletion date, which can include, but is not limited to, EV information for any past reporting period, projected EV information for any future reporting period, statistical EV information, and statistical cost depletion date information derived from statistical EV information. Module or segment 52 will be referred to as a “CDD analyzer” 52. An object link 54 is established between the CDD analyzer 52 and the project management software 56; which software 56, by way of example, is shown as Microsoft Project®, with one or more data files. Object link 54, which may be an object link (OLE2) in Microsoft® VISUAL BASIC, allows information, such as task data, to be delivered upon request to CDD analyzer 52. CDD analyzer 52 may also receive information by a data link 58 from a historical data file 60, which can contain appropriate data, such as project task data, EV information, and EV-related information. File 60 may be a floppy disk or hard disk or other storage medium accessible to CDD analyzer 52 on computer 120.

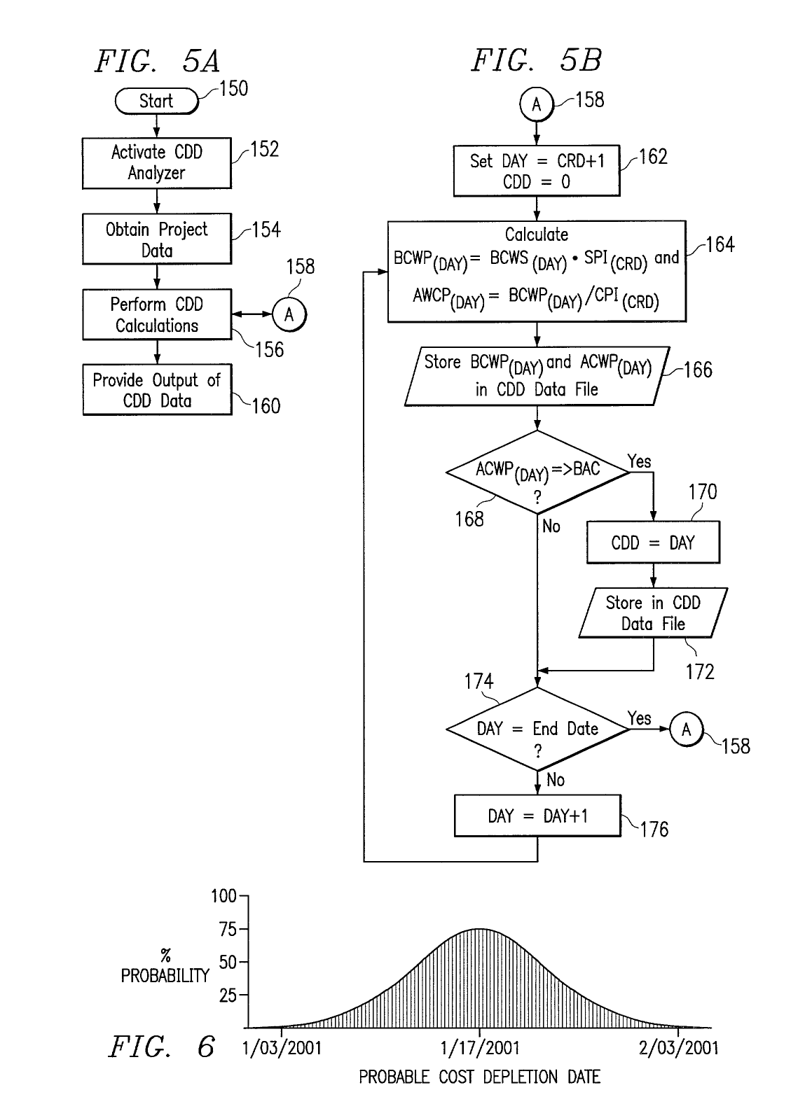

Referring now to FIG. 5A and 5B, a flowchart illustrating one exemplary process flow for a method according to the present invention is shown. The basic events are presented and then described in more detail further below. The process is accomplished with architecture 50 (FIG. 4) described above as part of system 100 (FIG. 3). After starting at block 150, the first step is for the CDD analyzer to be activated, as shown in block 152. Then, a specific project schedule file or historical data file is opened to obtain the project/task data and EV data at the current reporting date (CRD), as shown at block 154. For example, the EV data can include the following data calculated at the current reporting date: the cumulative BCWP; the cumulative BCWS; the cumulative ACWP; the schedule performance index (SPI), which is the cumulative BCWP divided by the cumulative BCWS; and the cost performance index (CPI), which is the cumulative BCWP divided by the cumulative ACWP. The CDD analyzer program segment is then initiated to perform the CDD calculations, as shown at blocks 156 and 158. Once initiated, current CDD information is calculated by the CDD analyzer, as shown in blocks 158 to 176. The CDD information can then be provided in any desired output format, e.g., in a graphic, table, and/or explanatory report format, as shown at block 160.

Once the CDD analyzer is activated, as illustrated in FIG. 5B, the variable DAY is set to the next successive reporting period (e.g., CRD+1) and the variable CDD is initialized, e.g., set to zero, as shown in block 162. Note that the reporting period can be chosen to be any desired period, such as for example, a day, a week, a month, a quarter, a year, and a decade. Using the cumulative SPI of the current reporting date, the cumulative BCWP is first calculated by multiplying the cumulative SPI and the cumulative BCWS for the reporting period being analyzed, i.e., (CRD+1). Then the cumulative ACWP for the reporting period being analyzed is calculated by dividing the cumulative BCWP for the reporting period being analyzed with the cumulative CPI of the current reporting date. These two steps are shown in block 164. The cumulative BCWP and the cumulative ACWP calculated for the reporting period being analyzed can then be stored in a CDD data file, as shown in block 166. If the cumulative ACWP for reporting period being analyzed is greater than or equal to the budget at completion, then the variable CDD is set equal to value of the variable DAY and stored in the CDD data file, as shown in blocks 168 to 172. The process illustrated in blocks 164 to 172 is repeated for each successive reporting period until the variable DAY is equal to the project baseline finish date, as illustrated by blocks 174 and 176. Note that all of the information obtained for a particular reporting period can be saved to a data file and/or displayed in any desired format after the completion of each iteration.

The information in the CDD data file obtained from the CDD analyzer can then be presented in a graph, as provided in FIG. 2, or in a report. Furthermore, the project manager can further determine the additional amount of funding needed to complete the project by comparing the projected cumulative ACWP with cumulative BWCS at the project baseline finish date.

An additional option for presenting historical information is to construct a report of historical data. This may be accomplished by analyzing previous EV information for previous time reporting increments. Thus, the task data may be obtained through the object link 54 (FIG. 4) and decomposed or analyzed at different increments to obtain historical EV information and EV-related information at each increment. The decomposition involves calculating for each reporting time increment, e.g., each day or each week, between the baseline project start date and the current date, the CPI, SPI, BCWP, BCWS, ACWP, CV% and SV%. The data points corresponding to each reporting time increment may then be used to prepare the historical EV information, the current EV information, as well as the CDD information. The historical data alone or with the current data may then be displayed.

In another embodiment of the present invention, the CDD information can be further subjected to probability and statistical analysis. Analysis under probability and statistics is well known to the skilled artisan, as described in the CRC Standard Mathematical Tables, 26th Ed., pp. 503-559 (CRC Press, Inc. 1984), which is incorporated herein by reference. For example, instead of using the cumulative SPI and cumulative CPI calculated at the current reporting date, the SPI and the CPI from each reporting period from the start date to the current reporting date can be used to obtain the arithmetic, weighted arithmetic, geometric, or harmonic mean SPI and CPI, which can then be used as described above to obtain the most probable cost depletion date.

Alternatively, the CDD can be individually calculated, as described above, for each SPI and CPI from each reporting period from the start date to the current reporting date. Then the various CDD data points can be further analyzed using probability and statistics to provide probable cost depletion dates. This data can then be provided in a report or graphical display, as illustrated in FIG. 6.

Although the present invention and its advantages have been described in detail, it should be understood that various changes, substitutions, and alterations can be made therein without departing from the spirit and scope of the invention as defined by the appended claims.

What is claimed is:

1. A system for monitoring and assessing the performance of a project, the system comprising:
a computer; and
a software program associated with the computer, the software program and computer operable in combination to:
receive project task data and earned value information from a project management software file or a historical data file;
determine cost depletion date (CDD) information from the project task data and earned value information; and
display the cost depletion date information.

2. The system of claim 1, wherein the cost depletion date information includes cost depletion date related information.

3. The system of claim 1, wherein the software program and computer are further operable to
determine historical, present, and projected earned value information; and
display the historical, present, and projected earned value information.

4. The system of claim 3, wherein the software program and computer are operable to determine the CDD information by accessing a historical data file.

5. The system of claim 4, wherein the software program and computer are operable to determine the historical earned value information by decomposing project task data.

6. The system of claim 1, wherein the software program and computer are operable to obtain the CDD information by:
calculating a cumulative cost performance index (CPI) and a cumulative schedule performance index (SPI) at a current reporting date (CRD) from the project task data, or the earned value information, or both;
utilizing the cumulative CPI and SPI to calculate a cumulative actual cost of work performed (ACWP) and a cumulative budgeted cost of work performed (BCWP)for each reporting period from the CRD to a project baseline finish date; and
determining a cost depletion date at which the cumulative actual cost of work performed (ACWP) is equal to or greater than the budget at completion (BAC).

7. The system of claim 6, wherein the reporting period is selected form the group consisting of a day, a week, a month, a quarter, a year, and a decade.

8. The system of claim 6, wherein the cumulative cost performance index (CPI) and the cumulative schedule performance index (SPI) are replaced by arithmetic, weighted arithmetic, geometric, or harmonic mean statistical CPI and SPI obtained from the SPI and CPI from each reporting period from a start date to the current reporting date.

9. The system of claim 6, wherein the software program and computer are further operable to:
store in the data file for each reporting period from the CRD to a project baseline finish date information selected from the group consisting of the cost depletion date, the calculated cumulative actual cost of work performed (ACWP), the calculated cumulative budgeted cost of work performed (BCWP), the corresponding reporting period, and combinations thereof.

10. The system of claim 1, wherein the software program and computer are operable to determine the CDD information by:
calculating a cumulative cost performance index (CPI) and a cumulative schedule performance index (SPI) at a current reporting date (CRD) from the project task data, or the earned value information, or both;
utilizing the cumulative CPI and SPI to calculate a cumulative actual cost of work performed (ACWP) and a cumulative budgeted cost of work performed (BCWP)for a successive reporting period following the CRD; and
setting a cost depletion date equal to the reporting period being analyzed if the cumulative actual cost of work performed (ACWP) is equal to or greater than the budget at completion (BAC);
wherein the last two steps are repeated for each successive reporting period until a project baseline finish date is reached.

11. The system of claim 10, wherein the reporting period is selected form the group consisting of a day, a week, a month, a quarter, a year, and a decade.

12. The system of claim 10, wherein the system is further operable to:
statistically analyze a plurality of cost depletion dates to obtain a probability of each cost depletion date; and
display the plurality of cost depletion dates and their corresponding probabilities.

13. The system of claim 10, wherein the software program and computer are further operable to:
store in the data file for each reporting period from the CRD to a project baseline finish date information selected from the group consisting of the cost depletion date, the calculated cumulative actual cost of work performed (ACWP), the calculated cumulative budgeted cost of work performed (BCWP), the corresponding reporting period, and combinations thereof.

14. A method of monitoring and assessing the performance of a project, comprising:
receiving project task data and earned value information from a project management software file or a historical data file;
determining cost depletion date (CDD) information from the project task data and earned value information; and
displaying the cost depletion date information.

15. The method of claim 14, wherein the cost depletion date information includes cost depletion date related information.

16. The system of claim 14, wherein the software program and computer are operable to determine the CDD information by accessing a historical data file.

17. The system of claim 16, wherein the software program and computer are operable to determine the historical earned value information by decomposing project task data.

18. The method of claim 14, wherein the CDD information is obtained by:
calculating a cumulative cost performance index (CPI) and a cumulative schedule performance index (SPI) at a current reporting date (CRD) from the project task data, or the earned value information, or both;
utilizing the cumulative CPI and SPI to calculate the cumulative actual cost of work performed (ACWP) and the cumulative budgeted cost of work performed (BCWP) for each reporting period from the CRD to a project baseline finish date; and
determining a cost depletion date at which the cumulative actual cost of work performed (ACWP) is equal to or greater than the budget at completion (BAC).

19. The method of claim 18, wherein the reporting period is selected form the group consisting of a day, a week, a month, a quarter, a year, and a decade.

20. The method of claim 18, wherein the cumulative cost performance index (CPI) and the cumulative schedule performance index (SPI) are replaced by arithmetic, weighted arithmetic, geometric, or harmonic mean statistical CPI and SPI obtained from the SPI and CPI from each reporting period from a start date to the current reporting date.

21. The method of claim 18 further comprising:
storing in the data file for each reporting period from the CRD to a project baseline finish date information selected from the group consisting of the cost depletion date, the calculated cumulative actual cost of work performed (ACWP), the calculated cumulative budgeted cost of work performed (BCWP), the corresponding reporting period, and combinations thereof.

22. The method of claim 14, wherein the CDD information is obtained by:
calculating a cumulative cost performance index (CPI) and a cumulative schedule performance index (SPI) at a current reporting date (CRD) from the project task data, or the earned value information, or both;
utilizing the cumulative CPI and SPI to calculate a cumulative actual cost of work performed (ACWP) and a cumulative budgeted cost of work performed (BCWP)for a successive reporting period following the CRD; and
setting a cost depletion date equal to the reporting period being analyzed if the cumulative actual cost of work performed (ACWP) is equal to or greater than the budget at completion (BAC);
wherein the last two steps are repeated for each successive reporting period until a project baseline finish date is reached.

23. The method of claim 22, wherein the reporting period is selected form the group consisting of a day, a week, a month, a quarter, a year, and a decade.

24. The method of claim 22 further comprising:
storing in the data file for each reporting period from the CRD to a project baseline finish date information selected from the group consisting of the cost depletion date, the calculated cumulative actual cost of work performed (ACWP), the calculated cumulative budgeted cost of work performed (BCWP), the corresponding reporting period, and combinations thereof.

25. The method of claim 22, further comprising:
statistically analyzing a plurality of cost depletion dates to obtain a probability of each cost depletion date; and
displaying the plurality of cost depletion dates and their corresponding probabilities.
